(19) United States
(12) Patent Application Publication
(10) Pub. No.: US 2013/0260067 A1
(43) Pub. Date: Oct. 3, 2013

(54) ATTACHABLE POCKET DEVICE AND METHOD FOR PROVIDING A POCKET ON A SURFACE

(71) Applicant: Olga Andreadis, Plainview, NY (US)

(72) Inventor: Olga Andreadis, Plainview, NY (US)

(21) Appl. No.: 13/478,641

(22) Filed: May 23, 2012

Related U.S. Application Data
(60) Provisional application No. 61/617,308, filed on Mar. 29, 2012.

(51) Int. Cl. B32B 1/08; B31B 1/00; B32B 1/04

(52) U.S. Cl. 428/35.5; 428/35.2; 493/267

(57) ABSTRACT

A pocket device is described that can be comprised of an attachable face layer having a perimeter portion and a portion configured as an opening. The perimeter portion is adapted to engage a surface thereby forming a cavity or pocket accessible through the opening portion or some other opening on the pocket device. Depending on the direction of the pocket and how it is adhered to the surface, the opening can be on the uppermost, left or right side. The pocket device can also be comprised of a support layer that has a front side and a backside. The front side can be configured to adhere to the face layer at or near the perimeter portion so as to form a pocket accessible through the top portion.

### PRIORITY CLAIM

This application claims the benefit of priority of U.S. Provisional Patent Application No. 61/617,308, filed Mar. 29, 2012, which is incorporated herein by reference in its entirety.

### FIELD OF THE INVENTION

The invention relates generally to an attachable pocket device that can be used for many applications and a method for providing a pocket on a surface.

### BACKGROUND

Pockets have been used for many years in many applications. Such pockets have been manufactured in various shapes and sizes. Most pockets however are designed for a specific purpose and are not adjustable in size nor attachable and removable from one location to the next.

There are a number of solutions for attaching pockets. Some of these solutions attempt to attach a pocket to a surface, but these solutions fail to meet the needs of the industry because the pocket that is attachable is fabricated from a rigid plastic material that is not expandable or adjustable in size.

There exists a need therefore for a pocket that is attachable, and that is adjustable or expandable to accommodate difference-sized surfaces and different-sized objects intended to be placed into the pocket.

### SUMMARY

In one example embodiment, a pocket (or pouch) device is provided that is comprised of an attachable face layer. The face layer has a perimeter portion and a portion configured as an opening. The perimeter portion is adapted to engage a surface thereby forming a cavity or pocket accessible through the opening portion. In a related embodiment, the opening portion is accessible from an uppermost or top of the pocket. In another related embodiment, the opening portion includes a side opening of the face layer depending on the direction the face layer is attached to the surface.

In another example embodiment, a pocket device is provided that is comprised of a face layer. The face layer has a perimeter portion and a portion configured with an opening. The pocket device is further comprised of a support layer that has a front side and a backside. The front side is configured to adhere to the face layer at or near the perimeter portion so as to form a pocket accessible through the opening portion. In a related embodiment, the opening portion is located on the uppermost portion or a side portion of the face layer depending on the direction the pocket is adhered to the surface. The pocket device is configured to engage a surface at or near the perimeter portions of the face layer.

In still another example embodiment, a method is provided for forming a pocket on a surface. The method includes providing an attachable face layer, the face layer having a perimeter portion and a portion configured as an opening. The method includes providing means for engaging the perimeter portion of the attachable face layer to the surface, with the engagement means being disposed on the perimeter portion of the face layer. The method also includes disposing the perimeter portion of the face layer on the surface, thereby forming a cavity accessible through the opening or an uppermost portion. In a related embodiment, the opening portion is a side opening of the face layer depending on the direction the pocket is engaged to the surface. In yet another related embodiment, the opening portion is disposed on a front face or portion of the attachable face layer.

### BRIEF DESCRIPTION OF THE DRAWINGS

FIG. 1 shows a front perspective view of an example pocket device as taught herein.

FIG. 2 shows a top (or uppermost) view of the pocket device of FIG. 1.

FIG. 3 shows a side view of the pocket device of FIG. 1.

### DETAILED DESCRIPTION

Following below are more detailed descriptions of various embodiments of the invention described herein. In particular, the various embodiments disclosed herein describe a pocket or pouch device that contains perimeter portions that are adapted to engage a surface and a method for forming a pocket on a surface. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

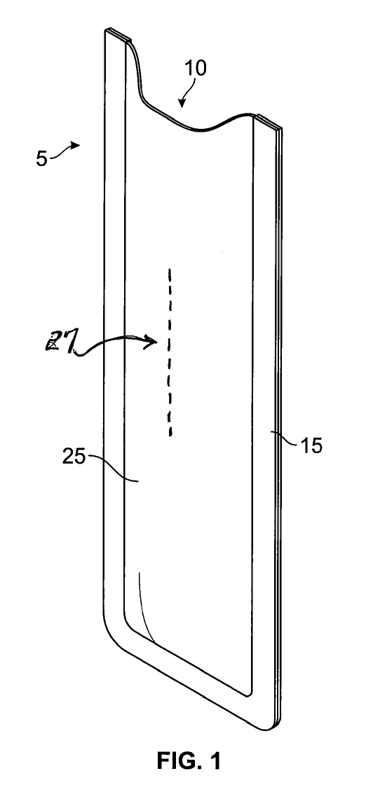

Referring to FIG. 1, in one example embodiment, a pocket device 5 is disclosed that can include a face layer 25. The face layer can include a top (or opening) portion 10 and one or more perimeter portions 15 that are configured to attach to a surface. In a related embodiment, a portion of the face layer is configurable with an opening portion that is disposed along the perimeter portion or about a front portion of the face layer in a slit formation.

In an example embodiment, attachable face layer 25 is made of a film that is made of a flexible material that can allow the attachable face layer 25 to dimensionally adjust in size. In one embodiment, attachable face layer 25 is made of a flexible film that can laterally adjust in size. In still other embodiments, attachable face layer 25 is made of a flexible film that can adjust longitudinally in size. In still other embodiments, attachable face layer 25 can be made of a flexible film that can adjust both laterally and longitudinally in size. In yet another related embodiment, face layer 25 is made from a rigid material providing an angled opening. In another related embodiment, the face layer includes accordion-like folds or pleats on one or more of perimeter portions 15 to allow for angled expansion of face layer 25 from the surface, thereby increasing the size of the pocket device.

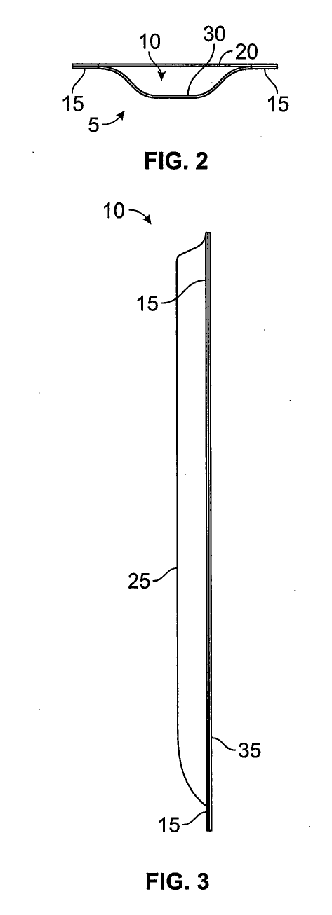

In an example embodiment, as shown in FIG. 2, the elastic deformation of the flexible film can create a cavity accessible from opening portion 10 or an uppermost portion of the attachable face layer 25. In still other embodiments, the elastic deformation of the flexible film can create a cavity accessible from a side portion of the face layer, depending on the direction the face layer is attached to a surface.

In another embodiment, the cavity can extend laterally so as to create a pocket wherein the surface 20 provides a back support for pocket 5. In this example, the volumetric size of the cavity is adjustable according to the degree of elastic deformity of the flexible film and can be selectively adjustable depending on the home, school, or office supplies being supported by the cavity.

Various embodiments of the flexible film of face layer 25 can include those with varying lengths and widths. In other example embodiments, the flexible film of face layer 25 can be made of an elastic polymer material such as plastic. In yet another example embodiment, the flexible film of face layer 25 can be made of various elastic materials such as fabric, rubber, mesh and nylon. In still other example embodiments, the flexible film of face layer 25 can be made of any material that has enough strength to support various home, school, and office supplies with at least enough force to overcome the force of gravity of the various home, school, and office supplies.

An example of a suitable flexible film is described in U.S. Publication No. 2010/0320260, published on Dec. 23, 2010, entitled “Flexible Cover for Food Container and Method of Manufacturing a Flexible Cover,” which is herein incorporated by reference in its entirety.

In an alternative example embodiment, attachable face layer 25 can be made of a film that is configured to be rigid with a flexible outer perimeter that can be used to adhere to a surface to form a pocket. In still other alternative embodiments, face layer 25 can be made of a two-sided material, and/or a combination of at least two materials adhered to one another to form a two-sided material.

In another example embodiment, as shown in FIG. 2, pocket device 5 can be configured with a textured inner surface 30 that can face an opposing surface to form a pocket. The textured inner surface 30 of pocket device 5 can be comprised of any texture that can inhibit the movement of at least one object within the cavity. In one example embodiment, the textured inner surface 30 is sufficiently rough or coarse so as to prevent or inhibit the one or more contents of the pocket from falling or spilling out when the pocket device 5 is tipped sideways in any direction or upside down or in the direction of the opening of the face layer.

Referring to FIG. 2, in one embodiment, pocket device 5 can be comprised of one or more perimeter portions 15 that can be engaged to any surface to create a pocket cavity. In one example embodiment, perimeter portions 15 can include means for engaging to a surface 20. As shown in FIG. 2, in one embodiment, surface 20 is comprised of any substantially planar surface. In other various embodiments, surface 20 is comprised of any surface that is capable of attaching to perimeter portions 15.

The means of engaging perimeter portions 15 to surface 20 can include any type of adherence component chosen from the group consisting of any type of adhesive system, a hook and loop system (e.g., Velcro), and a magnetic system. In one example embodiment, the adhesive system can include any type of adhesive, including without limitation a single-sided stick tape, a double-stick tape, a glue and/or a pre-dried adhesive or light, heat or chemically activated adhesive or composition. In a related example embodiment, the adhesive system can be comprised of a double-stick adhesive tape having elastic properties so that the tape can laterally and/or longitudinally adjust in size. In still another example embodiment, the adhesive system can be comprised of a double-stick tape wherein one side of the double-stick tape is affixed to perimeter portions 15 and the other side of the tape is covered with a removable backing. The backing can be peeled away before engaging perimeter portions 15 to surface 20.

In still other example embodiments, perimeter portions 15 can be coated with an adhesive using any conventional adhesive coating technique. In another example embodiment, perimeter portions 15 can be releaseably engaged to surface 20.

Referring now to FIG. 3, there is illustrated a side view of pocket device 5. In this example embodiment, pocket device 5 can be comprised of a support layer 35 having a front side and a back side. In one example embodiment, the front side of support layer 35 is configured to adhere to face layer 25 at perimeter portions 15 of the face layer so as to form a pocket accessible through an opening portion that includes a top or an uppermost portion of face layer 25 or a side portion of face layer 25 depending on the orientation of pocket device 5. In still other embodiments, the front side of support layer 35 is configured to adhere to face layer 25 at perimeter portions 15 of the face layer so as to form a pocket accessible through a side portion of face layer 25. In another example embodiment, the backside of surface layer 35 contains means for engaging to a surface. In another example embodiment, surface layer 35 can be engaged to a surface in various configurations so that a pocket device 5 can accommodate a variety of surfaces or can hang freely from the surface if it has an optional hanging device, such as a hook or loop.

The means of engaging support layer 35 to face layer 25 and/or any surface can include any type of adherence component chosen from any type of adhesive system, a hook and loop system (e.g., Velcro) and a magnetic system. In one example embodiment, the adhesive system can include any type of adhesive, including without limitation a single-sided stick tape, a double-stick tape, a glue and/or a pre-dried adhesive. In a related example embodiment, the adhesive system can be comprised of a double-stick adhesive tape having elastic properties so that the tape can laterally and longitudinally adjust in size. In still another example embodiment, the adhesive system can be comprised of a double-stick tape wherein one side of the double-stick tape is affixed to surface layer 35 and the other side of the tape is covered with a removable backing. The backing can be peeled away before engaging support layer 35 to perimeter portions 15 and/or any surface.

In still other example embodiments, support layer 35 can be coated with an adhesive using any conventional adhesive coating technique. In another example embodiment, support layer 35 can be releaseably engaged to any surface.

In another embodiment, support layer 35 can also be configured to include a flap portion at the top (or configured opening portion) end of support layer 35. In one embodiment, the flap portion is adapted to cover the top portion of face layer 25. In a related embodiment, the flap portion includes a fastening device, such a button, zipper, button, snap or the like that is adapted to engage face layer 25 to close the pocket. In yet another related embodiment, face layer 25 does not include a top portion but provides a slit or flap or opening 27 to facilitate access to the pocket from another part of the pocket (such as for a portable tissue dispenser or to access the contents from opening 27) of face layer 25. In yet another related embodiment, opening 10 is configured to be moved to one of the perimeter portions to create a longitudinal opening lengthwise along the pocket instead of at the top (so as to store glasses or items that you want to access laterally).

In another related embodiment, the pocket device has perimeter portions that can be disengaged from (or are releaseably engaged to) the surface such that portions of the perimeter portions are coupled (or attachable with each other) to each other to form a self contained pouch disassociated from the surface. In a related embodiment, pocket device 5 includes a sealing member thereon, which is selected from the group consisting of a flap, a zipper, a snap, a button, and a hook and loop unit, that is configured to seal the pocket device to keep the contents therein.

In a related embodiment, face layer 25 is made of a disposable or biodegradable paper or like material to allow for the entire pocket to be detached and folded in upon itself (the perimeters are attached to each other) to close off the contents, such as in a hospital or clinic setting where the contents are not be touched, and then the entire pocket device can be disposed of. In yet another related embodiment, pocket device 5 is configurable with or without a back plate or surface to be a standalone waste basket thereby saving the cost of waste baskets or garbage cans in bathrooms or public restrooms. This avoids the need to have to clean or wash out the garbage pails or replace them when they break or are too dirty to clean.

In yet another embodiment, face layer 25 is configured from a rigid and transparent material (or with a transparent window on it), with or without a backing, that would facilitate its use as a biohazard waste disposal container on a wall in hospital rooms or clinics.

An example of another pocket design is described in U.S. Publication No. 2006/0186006, published on Aug. 24, 2006, entitled “Portable Pocket” which is herein incorporated by reference in its entirety.

Other various embodiments of the invention include methods of forming a pocket on a surface. In one embodiment, a method of forming a pocket device 5 on a surface can include a step of providing a face layer 25 that is attachable to a surface 20. A further step can include providing means for engaging one or more perimeter portions 15 to a surface 20. In an example embodiment, the engagement means can be disposed on perimeter portions 15 of face layer 25. In still other embodiments, a method of forming a pocket on a surface can further include the step of disposing perimeter portions 15 of face layer 25 on surface 20 such that top portion 10 of face layer 25 is open thereby forming a cavity that is accessible through the uppermost portion or side portion of face layer 25 depending on which direction the opening of the pocket is adhered to the surface. The method of forming a pocket on a surface can further include the step of deforming face layer 25 to increase the size of pocket cavity, so as to provide a pocket cavity which is selectively adjustable to accommodate a variety of contents.

While the various embodiments of the invention have been described above in terms of specific embodiments, it is to be understood that the invention is not limited to these disclosed embodiments. Upon reading the teachings of this disclosure, many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. A pocket device comprising:
an attachable face layer, the face layer having a perimeter portion and a portion configured with a deformation, the perimeter portion adapted to removably engage a surface, wherein a portion of said perimeter does not adhere to said surface and the portion configured with a deformation forming a cavity or pouch with an opening portion when the perimeter portion is removably engaged to said surface, said cavity or pouch being accessible through the opening portion.

2. The pocket device of claim 1 wherein the attachable face layer is a film comprised of a flexible material that allows the face layer to dimensionally adjust in size.

3. The pocket device of claim 1 wherein the face layer is comprised of a material chosen from a film, an elastically deformable material, a rigid material, a two-sided material, and a combination of at least two materials adhered to one another.

4. The pocket device of claim 1 wherein the face layer includes a sealing member adapted to seal or close the pocket device at the opening portion.

5. The pocket device of claim 1 wherein the face layer is further comprised of a textured inner surface adapted to inhibit movement of at least one object within the cavity.

6. (canceled)

7. The pocket device of claim 1 wherein the perimeter portion includes means for engaging the perimeter portion to the surface, the engagement means being comprised of an adherence component selected from the group consisting of an adhesive system, a hook and loop system, and a magnetic system.

8. The pocket device of claim 7 wherein the adhesive system is selected from the group consisting of a single-sided stick tape, a double-stick tape, a glue, and a pre-dried adhesive, and a light, heat and chemically activated composition.

9. The pocket device of claim 1 further comprising a support layer having a front side and a backside, the front side configured to adhere to the face layer at or near the perimeter portion.

10. (canceled)

11. The pocket device of claim 9 wherein the backside of the support layer includes means for engaging the backside to the surface, the engagement means being comprised of an adherence component selected from the group consisting of an adhesive system, a hook and loop system, and a magnetic system.

12. A method of forming a pocket on a surface, the method comprising:
providing an attachable face layer, the face layer having a perimeter portion and a portion configured as an opening;
providing means for engaging the perimeter portion to the surface, said engagement means disposed on the perimeter portion of the face layer; and
disposing the perimeter portion of the face layer on the surface, thereby forming a cavity accessible through the opening portion.

13. The method of claim 12, further including the step of deforming the face layer so as to increase the size of the cavity.

14. The method of claim 12, further including the step of engaging portions of the perimeter portion so as to form a self contained pouch disassociated from the surface.

15. A pocket device comprising:
a face layer, the face layer having a perimeter portion and a portion configured with a deformation, the perimeter portion adapted to removably engage a support layer, the support layer having a front side and a backside, the front side configured to adhere to the face layer at or near the perimeter portion so as to form a pocket accessible through an opening portion;
wherein the pocket is configured to engage a surface at or near the perimeter portion of the face layer.

16. The pocket device of claim 15, wherein the pocket is configured to removably engage a surface at least at the backside of the support layer.

17. The pocket device of claim 16, wherein the pocket is removably engaged to a surface by an adherence system.

18. The pocket device of claim 1, wherein the opening portion includes an opening on a front portion of the face layer, and wherein the perimeter portion is adapted to removably engage a surface thereby forming a cavity or pocket accessible through the opening.

19. (canceled)

20. The pocket device of claim 4, wherein the sealing member is selected from the group consisting of a flap, a zipper, a snap, a button, and a hook and loop unit.

21. A pocket device consisting of:
A singular attachable face layer, the singular attachable face layer having a perimeter portion, the perimeter portion adapted to permanently engage a surface on three or less sides, the perimeter portion not engaged with a surface forming a cavity or pouch, said cavity or pouch being accessible through an opening portion.
